(19) United States
(12) Patent Application Publication
(10) Pub. No.: US 2008/0053528 A1
(43) Pub. Date: Mar. 6, 2008

(54) Diaphragm pressure balancing valves

(76) Inventor: Silvano Breda, Toronto (CA)

Correspondence Address: IVOR M. HUGHES, BARRISTER & SOLICITOR,;PATENT & TRADEMARK AGENTS, 175 COMMERCE VALLEY DRIVE WEST, SUITE 200, THORNHILL, ON, L3T 7P6, CA

(21) Appl. No.: 11/896,330

(22) Filed: Aug. 31, 2007

Related U.S. Application Data
(60) Provisional application No. 60/841,512, filed on Sep. 1, 2006.

(51) Int. Cl. G05D 23/13

(52) U.S. Cl. 137/98

(57) ABSTRACT

A simplified diaphragm pressure balancing valve assembly is claimed with a body having inlet and outlet water ports selectively connected to supply a shower or a spout. The body includes a cylindrical opening to receive a cartridge assembly including inlet and outlet parts for alignment with the inlet and outlet ports of the body. A compact stationary pressure balancing device is provided, to avoid scalding of a bather, which remains stationary when the valve is operated. The assembly includes a disc assembly which is selectively moveable in relation to each of the sealed hot and cold water outlet ports, allowing water to pass out of the cartridge, exiting the valve to a spout or a shower. Supplementary members of the housing, for example a trim nut and body nut, are provided to ensure a press fit between the members and the disc.

### CROSS REFERENCE TO RELATED APPLICATION

This application claims the benefit of U.S. Provisional Application No. 60/841,512 filed Sep. 1, 2006.

### FIELD OF THE INVENTION

The present invention relates to a single handle mixing valve for tub spouts and shower heads and more particularly to pressure balanced, volume and temperature controlled mixing valves.

### BACKGROUND OF THE INVENTION

Most governing codes require that any tub or shower mixing valve include some kind of a pressure balancing mechanism which is capable of responding to abrupt changes in pressure of the hot and cold water supplies within a very short time to restore the balance of the output flows of hot and cold water to the same proportion as they were before the pressure fluctuation occurred.

Because such mixing valves must fit into a confined space, compromises must be made between performance of the valve and the space required for the valve in plumbing installations. Most prior art valves use a spool type poppet valve mechanism to provide a pressure balance for the hot and cold water supplies feeding the valve. Some of the prior art pressure balancing mechanisms are sufficiently complex so as to require the services of sophisticated service personnel to overhaul, dismantle or repair prior art valves.

It will be immediately apparent that a single handle mixing cartridge valve of a compact size yet capable of controlling large flows of hot and cold water according to pressure fluctuations in the inlet supplies is very desirable. Such a valve advantageously should include a single cartridge that is easily removed for repair or replacement.

### RELEVANT PRIOR ART

U.S. Pat. No. 5,501,244 Issued Mar. 26, 1996 teaches a single handle pressure balancing mixing valve which uses a diaphragm actuated poppet valve to accomplish the balancing function. The two balancing chambers on opposed sides of the diaphragm are pressurized at all times, requiring check valves at the inlets of the valve. Water leaves the balancing chambers by moving toward the handle so that the valve stem is subjected to the outlet water pressure during operation of the valve. As the valve ages and wears, it is possible that water may leak at the valve stem. The throughflow through the valve tends to be somewhat throttled by partial flow restriction provided by the poppet mechanism.

U.S. Pat. No. 5,441,076 Issued Aug. 15, 1995 teaches a single handle pressure balancing mixing valve utilizing a stationary cartridge in which a sleeve type valve shuttles back and forth driven partially by a diaphragm in response to fluctuations in input pressures. Because of the small area allowed for water passage in the throttle area, the valve is limited to applications where a relatively low throughput is acceptable. The output flow of water from the pressure balancing chambers is toward the valve stem and this valve may be prone to leakage at the valve stem as the various valve components are subjected to wear and scale build up. This valve also requires the presence of check valves to prevent cross-flow at the inlets.

U.S. Pat. No. 5,355,906 Issued Oct. 18, 1994 teaches a single handle pressure balancing mixing valve using a spool type poppet valve to achieve pressure balance control. Water flow in the valve is from the end of the valve remote from the stem toward the stem. Because the pressurized exit chamber of the valve is at the valve stem, leaking at the stem end of the valve may occur as the mechanism is subjected to wear and scale build up.

Flow rate through the poppet mechanism is somewhat restricted because of the construction of the piston and its surrounding chamber. The piston may have a sticking problem when utilized in low water supply pressure situations. Scale build up may be a problem. This valve also has an adjustable stop mechanism to limit the flow of hot water which may pass through the valve into the mixing chamber so that the maximum temperature of the water delivered by the valve may be preset to an acceptable temperature level.

U.S. Pat. No. 6,325,089 to Breda teaches a valve that uses a rotatable pressure balancing chamber including a pair of exit ports in communication with the water balancing chambers on either side of the diaphragm equipped shuttle to control the water outlet mixture which responds to changes in inlet pressure in the respective balancing chambers to throttle the water through the valve. The pressure balancing chambers are isolated from the water supplies feeding the valve when the valve is in the “off” position. The pressure balancing chambers are pre-pressurized before any water is permitted to exit from the valve. However providing a rotatable balancing chamber has its own limitations with respect to operation and maintenance.

The following represents an analysis of the construction of the teachings of my prior patent and specifies the particular deficiencies in that structure. The valve of the '089 Patent was never manufactured for many reasons including the fact that the costs of manufacture were not acceptable and the valve construction is complicated which the present invention addresses. The construction of my '089 Patent includes water flow from the bottom of the cartridge and from the housing as best seen in relation to FIG. 3 and ports 64, 66, 174 and 173. The construction included two half shells which captured therein the pressure balancing shuttle. The cartridge fit into a stationary sleeve held within the body. A mixing chamber occurred in the space between the stationary sleeve and the cartridge. With the mixing chamber being defined inside of the cartridge the hot and cold water could migrate across the seals at the hot and cold inlet which were not entirely isolated. Further the shuttle would be rotated along with the cartridge and more effort would be required to move the cartridge between the hot and cold adjustable positions. Further because the mixing chamber was internal the cartridge assembly was more prone to the wear and tear normally associated with sediment. The assembly included two mating ceramic discs located at the bottom of the cartridge, one stationary and one moveable to control the flow out of the valve. It was difficult to justify bringing it to market. The details of my U.S. Pat. No. 6,325,089 in its entirety are incorporated by reference in its entirety as if it was fully included within this specification.

The present invention provides a construction which is much simplified and easier to manufacture with considerably less parts involved. The cost of manufacture is significantly less. However in providing the stationary shuttle assembly in the valve it is necessary to make provision for a check valve on the inlets of the water supply to ensure that no cross-contamination exists.

It is therefore a primary object of this invention to overcome all of the deficiencies in the prior art including my prior patent and provide a compact, simplified, easy to manufacture improved diaphragm pressure balancing valve assembly which addresses the deficiencies found in my prior construction and those of the prior art.

It is a further object of this invention to provide a stationary cartridge assembly contained within the improved diaphragm pressure balancing valve assembly of the present invention wherein only a preferably stainless steel disc assembly moves when the handle is operated.

It is a further object of the invention to provide an improved diaphragm pressure balancing valve assembly which is easier to use for those who may be physically challenged.

It is a further object of this invention to provide a single handle pressure balancing mixing valve wherein the pressure balancing mechanism is more sensitive to fluctuations in input water pressure than prior art valves.

It is a further object of this invention to supply a single handle pressure balancing mixing valve which utilizes comparatively large water outlet passageways and is essentially silent in operation and not prone to producing water hammer.

Further and other objects of the invention will be apparent to one skilled in the art in reading the following summary of the invention and the more detailed description of the preferred embodiments illustrated herein.

### SUMMARY OF THE INVENTION

According to a preferred embodiment of the invention there is provided an improved diaphragm pressure balancing valve assembly comprising a valve body having inlet and outlet ports for the flow of water into the valve and from the valve to a shower or a spout, said body including an opening being generally cylindrical at one end thereof to receive a cartridge assembly, said cartridge assembly including inlet and outlet parts for alignment with the inlet and outlet ports of the body, said cartridge including a stationary pressure balancing device and preferably as taught in my '089 Patent, namely a cylinder upon which rides a shuttle assembly including a diaphragm responsive to pressure differences causing the motion of the shuttle on the cylinder assembly, said diaphragm including a pressure balancing area at each side proximate the hot and cold water entry into the cartridge, the assembly including selective hot and cold water outlet ports in engagement with a preferred stainless steel disc assembly being moveable in relation to each of the hot and cold water outlet ports of the cartridge, each outlet being sealed by resiliently biased seals against which the preferred stainless steel plate presses, said preferred stainless steel disc being rotatable to and from positions allowing water to pass out of the cartridge, and then around the mixing chamber located between the body and the cartridge and subsequently exiting the valve to a spout or a shower, the preferred stainless steel member being held in position and being press fit in engagement with a cartridge sleeve and with a stem portion of the valve, said cartridge being held in position by supplementary members of the housing for example including a trim nut and body nut to ensure a press fit between the members and the preferred stainless steel member; wherein a much simplified, compact, cost effective device has been provided with the pressure balancing shuttle being substantially stationary as the valve is operated.

In a preferred embodiment of the invention the stainless steel disc includes cooperating hot and cold water outlets having a generally kidney-shaped construction including a bulbous head at one end and a tail like portion at the other. The purpose of the construction of these outlets is to increase flow through the valve in relation to prior art embodiments, and in particular as best seen in relation to FIG. 41 with respect to openings K1 and K2 as one example. As shown in FIG. 41 because of the bulbous end of each of these openings K1 and K2 in the stainless steel disc 17 there is provided the ability to provide higher flow rate as the valve rotates from the off position through the 100% cold water, at 50/50 and 100% hot water. The general kidney shape of the opening through the stainless steel disc 17 provides this feature. Therefore any equivalently performing shape will suffice although the preferred shaped that Applicant has ascertained relates to the generally kidney-shaped or comet-like shape having a tail and a bulbous head at opposite ends.

Accordingly there is provided a stainless steel disc assembly for an improved diaphragm pressure balancing assembly wherein said pressure balancing assembly within said assembly is stationary and the shuttle does not move with the operation of the cartridge but only in response to pressure differentials and only the stainless steel disc moves as the cartridge is operated from the desired positions such as from the comfort positions for the individual using the valve. The details of the preferred embodiments of the invention will be described hereinafter in relation to the figures.

This invention is directed to a single handle pressure balancing mixing valve which has a cartridge incorporating a pressure balancing mechanism within its casing which is not rotatable. An actuating stem to which a handle is attached is rotated to operate the valve. In rotating the stem a water flow control platen, preferably stainless steel, having enlarged offset hot and cold preferably kidney shaped openings are moved to open or shut off the hot or cold water flow exiting the cartridge to a mixing chamber defined between the body and the cartridge. The cartridge includes a pressure chamber on either side of a diaphragm equipped shuttle which responds to changes in pressure in the respective chambers to throttle the water through the valve in response to changes in inlet pressures. The cartridge will pass the flow of separate hot and cold water to the water flow control platen. The platen is pressed against two separate hot and cold water spring biased seals surrounding the exit ports from the cartridge downstream of the balancing chamber. The cartridge is accessible and removable from the stem end of the valve mechanism by the simple removal of a retainer.

The use of a diaphragm, in association with the sleeve type balancing mechanism slidably mounted on a stationary tube in the cartridge, assures a smooth immediate response to small fluctuations in supply pressure during operation of the valve. At the same time, by maintaining the diaphragm stationary as taught with this improvement, the resulting balancing mechanism of my pressure balancing valve is more precise in its action as well as less prone to “sticking” due to the accumulation of scale and sludge on the balancing sleeve.

The valve of this invention effectively positions the pressure balancing chamber from the feed water supply when the valve is in the “off” position. Turning the valve “on” allows water to flow through the various water passages. By maintaining the chambers stationary during the operation of the valve, a more precise compensation of water pressure differentials is attained. The motion of the platen will therefore cause water to flow through to the mixing chamber, at 100% hot, 50/50 hot and cold, and 100% hot enhancing the flow capabilities of the valve to 10 gallons per minute, because of the large substantially kidney shaped outlets of the platen.

Another aspect of this invention is the inclusion of an adjustable stop mechanism to adjust and limit the rotational travel of the platen so that the flow of the hot water may be restricted to a preset flow rate by adjusting the position of the hot water stop of the valve. This adjustment may be conveniently carried out from a point outside the valve housing even after the valve is permanently installed and water is flowing in the valve. At any point in time both the hot and cold water flows can be shutoff by operating stops conveniently built into the body of the valve disposed at the inlets. The outlet to the tub spout is the preferred outlet of the valve by the provision of a venturi outlet to the shower of reduced cross section. Flow will be sent to the shower through the operation of a diverting mechanism only.

This invention provides a single handle pressure balancing mixing valve wherein the pressure balancing mechanism is more sensitive to fluctuations in input water pressure than prior art valves. The pressure balancing mechanism of applicant's valve continues to function even in the presence of lower inlet water pressure on both hot and cold water supplies than the prior art poppet type spool valves.

This invention provides a single handle pressure balancing mixing valve which utilizes comparatively large water passageways (the openings to the cartridge outlet upstream of the mixing chamber are substantially kidney shaped) and is essentially silent in operation and not prone to producing water hammer.

This invention provides a single handle pressure balancing valve which may be swiftly dismantled and rebuilt without the removal of screws or other complicated fastening devices requiring special tools and skills.

### BRIEF DESCRIPTION OF THE DRAWINGS

FIG. 1 illustrates incross section and side view of the valve illustrated in a preferred embodiment of the invention.

FIG. 2 illustrates a perspective view of the assembled valve illustrated in a preferred embodiment of the invention.

FIG. 3 illustrates a top view of the valve of FIG. 2.

FIG. 4 illustrates a cross section side view of the valve body illustrated in preferred embodiment of the invention.

FIG. 5 illustrates the valve body of FIG. 4 rotated 90 degrees.

FIG. 6 illustrates details of the assembly of disc plug 24 shown in a preferred embodiment of the invention.

FIG. 7 illustrates the water inlet check devices of FIG. 1 in closeup cross-section and perspective in a preferred embodiment of the invention.

FIG. 8 illustrates the opposite check to FIG. 7.

FIG. 9 illustrates in side view the check plug device 3 of FIGS. 7 and 8.

FIG. 10 illustrates the check plug of FIG. 9 in top view.

FIGS. 11 and 12 illustrates in perspective the trim nut 28 and body nut 29 best seen in FIG. 1.

FIGS. 13 to 16 illustrates in top and perspective views the stop ring 11 and temperature ring 12 best seen in FIG. 1.

FIGS. 17 and 18 illustrates in cross section the interior of the cartridge of the valve assembly shown in a preferred embodiment of the invention.

FIGS. 19 to 22 illustrates in cross-section, top and cutout perspective the waterways of the cartridge of FIG. 17 and shown in a preferred embodiment of the invention.

FIGS. 23 to 33 illustrates the shuttle assembly of FIG. 1 in perspective, and components thereof in cross-section and cross section in a preferred embodiment of the invention.

FIGS. 34 to 36 illustrates in cross-section the sequence of operation of the shuttle assembly of FIG. 23 in a preferred embodiment of the invention.

FIGS. 37 to 40 illustrates in cross-section the position of parts K1 and K2 of the stainless steel disc in relation to the outlets from the cartridge assembly and shown in a preferred embodiment of the invention.

FIGS. 41 to 44 illustrates the stainless steel disc 17 of the cartridge assembly and the corresponding grommet and spring in cross-section side and perspective views.

FIGS. 45 to 48 illustrate the cartridge stem of FIG. 1 in top, section and perspective views.

FIGS. 49 to 51 illustrate the cartridge sleeve of FIG. 1 in top, section and perspective views.

### DETAILED DESCRIPTION OF MY INVENTION AND THE IMPROVEMENTS THERETO

The valve assembly as shown has a generally cylindrical shape which is shown in a vertical orientation for convenience of illustration, but it will usually be found that the valve of this invention will be installed having its cylindrical axis disposed in a horizontal plane.

The housing 1 for the cartridge has a somewhat cylindrically shaped body composed of a suitable metallic material such as brass, copper or a suitable alloy thereof, white metal or some other suitable metallic material.

A sliding shuttle member, is slidably mounted on the tubular member. The shuttle is provided with a series of ports which communicate with ports in the tubular member respectively to allow for co-operative pressure balancing compensation.

The diaphragm of the shuttle is sealed between shells and during assembly of cartridge so as to divide the internal cavities formed on opposing sides of the diaphragm into two chambers. The diaphragm is received in grooves in said shells and respectively and is sealed by the compressive forces placed on the peripheral ring section of diaphragm during assembly of pressure balancing cartridge.

An adjustable stop washer is provided to enable a tradesman to adjust the upper limit of rotation of the spindle and to thus limit the maximum flow of hot water allowed to pass through the valve (for the safety of persons using the valve). A corresponding stop member engages the abutment at the end of the washer to define the “off” position (which is not adjustable) for the spindle and the cartridge of valve.

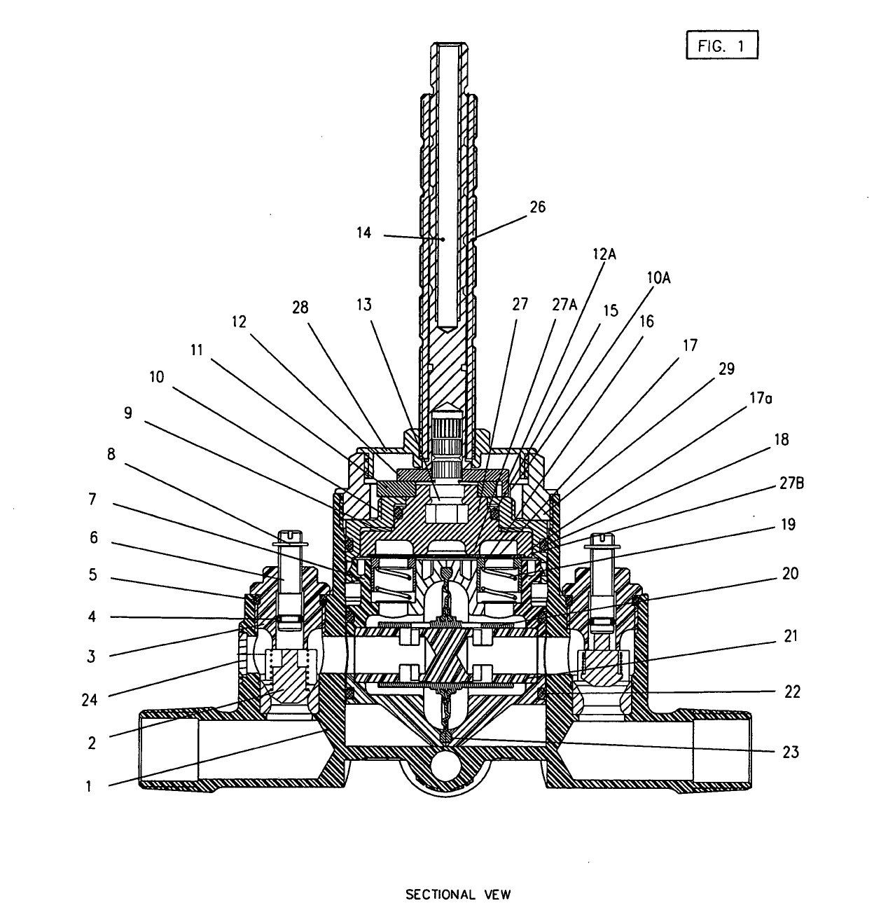

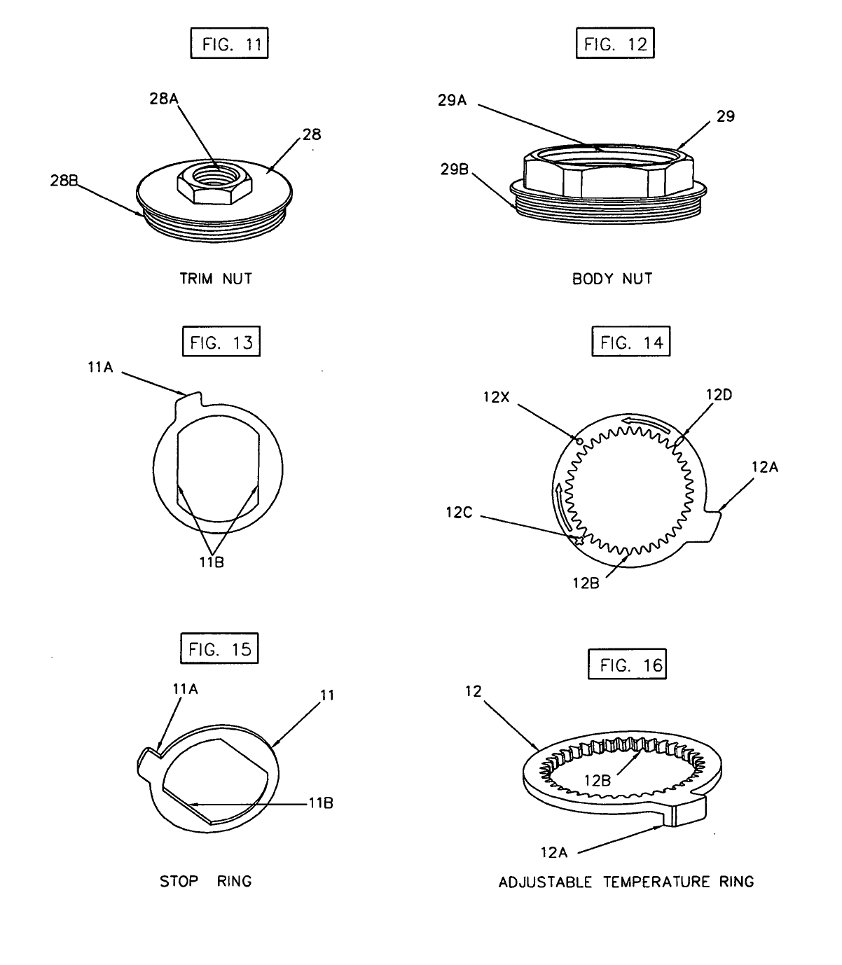

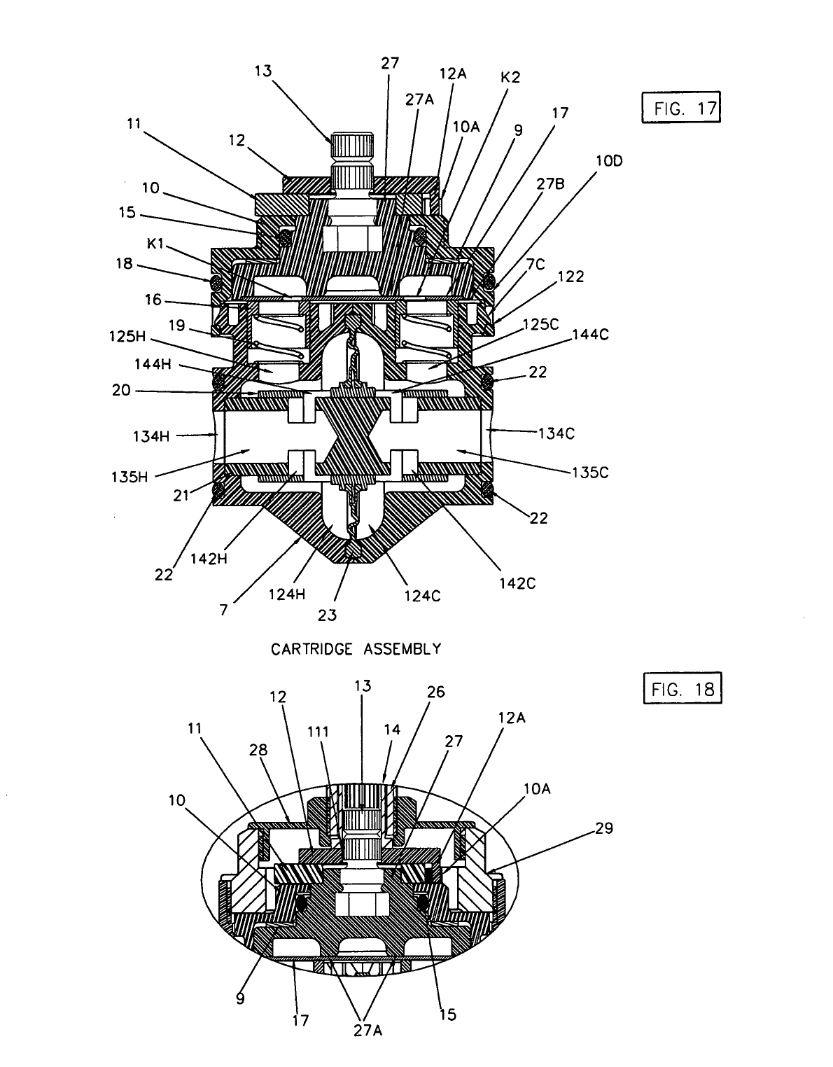

Referring now to the FIGS. 1 generally there is illustrated in perspective a housing 1 including hot and cold water inlets which have integrally provided therewith check valves to prevent cross over of hot and cold water which also act as stops for the flow of hot and cold water should it be necessary to change the cartridge. The details of these check valves is provided further in the disclosure but they are those known to one skilled in the art having the trademark NEOPERL™. The body therefore includes an opening best seen in FIG. 4 for receipt of a cartridge assembly including a cartridge sleeve 10 held in position by the necessary hardware including the trim nut and the body nut 28 and 29 of FIGS. 11 and 12 which hold in position the cartridge 10. The stationary sleeve 21 carries the shuttle assembly including diaphragm 23 as seen in FIG. 17. The details of a half shell construction and the diaphragm are found in my prior U.S. Pat. No. 6,325,089 therefore the details of the construction of the pressure balancing shuttle and the trim nut and body nut are consistent with that of my prior mentioned patent which are incorporated by reference in their entirety herein as if they occurred with this description.

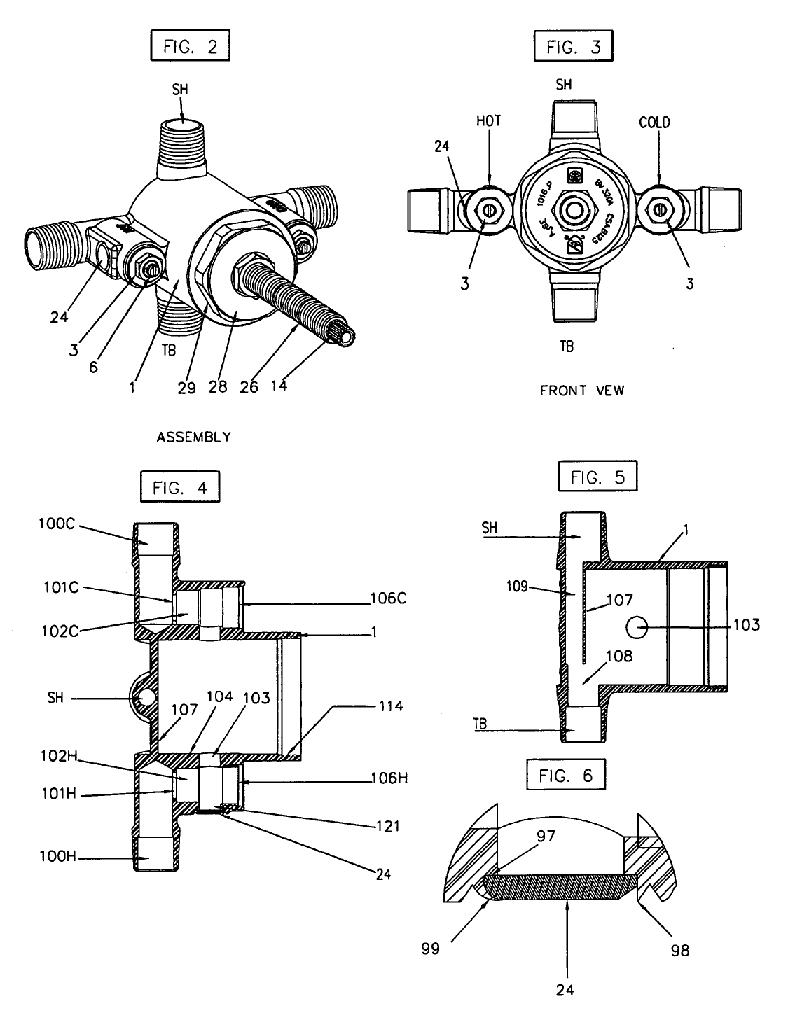

Referring now to FIGS. 1 to 3 it can clearly be seen that all the parts are assembled in association with one another with the outlets from the cartridge including seals 16 positioned within port 16a against the stainless steel moveable disc 17 held in position within the assembly and retained by the diverting stem 27 having portions 27b on the diverting stem 27 to engage the stainless steel disc 17 in a press fit relationship proximate portions 27b. The entire assembly is held together via the trim and body nuts 28 and 29. Water will therefore flow through the valve assembly, through the hot and cold water inlets, into the shuttle chamber causing the pressure balancing differential to be determined by the water pressure differences around the shuttle assembly as previously described in my prior patent, and out the outlets 16 for both hot and cold water. When in the closed position the stainless steel disc abuts against the sealing members 16 until such time as the stem is operated by a handle as described herein to move the stainless steel disc so that the kidney-shaped outlets are aligned in whole or in part with the opening 16a allowing water to pass around the perimeter assembly in the space defined between the body and the cartridge acting as a mixing chamber and ultimately out of the ports SH or TB from the valve as best seen in the perspective view of FIG. 2. The kidney-shaped openings of the stainless steel disc are offset to one another to provide for the alignment of 100% hot water flowing from the valve assembly, 50% hot 50% cold water flowing from the valve assembly and 100% cold water flowing from the assembly.

Refer now to the figures and initially particularly FIGS. 2 and 3, there is provided an improved pressure balancing single handle valve including a body 1, including inlets 100 H and 100 C for hot and cold water respectively. The valve also includes a shower outlet SH and a tub outlet TB orientated at 90 degrees to the water inlets. A hot and cold water shutoff and check 3 is provided for hot and cold water as best seen in FIG. 3 to enable shutoff of the water supply to the valve and for the simple replacement of the cartridge contained in the valve housing 1 which will be described hereafter. The shutoff mechanisms 3 are check plugs of the type manufactured by and under the trademark NEOPEARLE™, although the structure of these check mechanisms 3 will be described hereinafter. Such structure are known in the art. It is only the use of the NEOPEARLE™ construction with this present invention that is considered to be unique. The housing therefore 1 includes a trim nut 28 and a body nut 29 which work together to maintain the cartridge in position during the operation of the valve. The spline extension 14 on the sleeve 26 is utilized for maintaining a handle to allow the user to operate the valve. The handle is not shown with these illustrations.

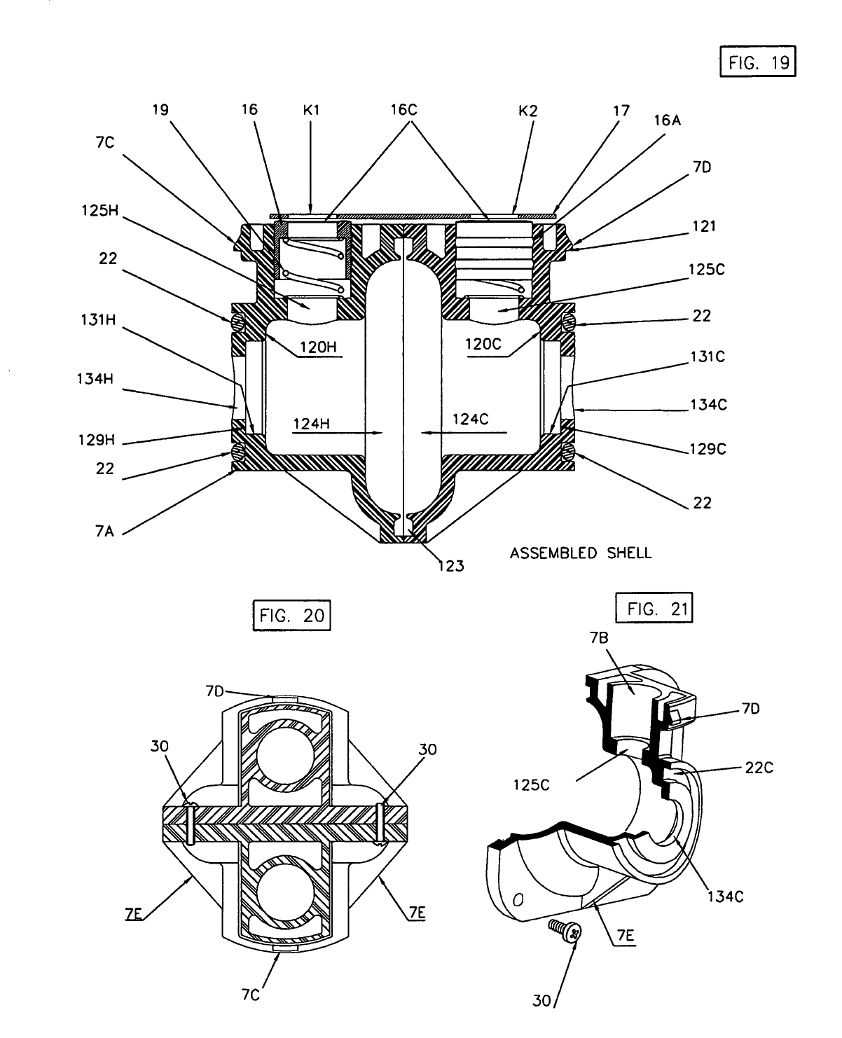

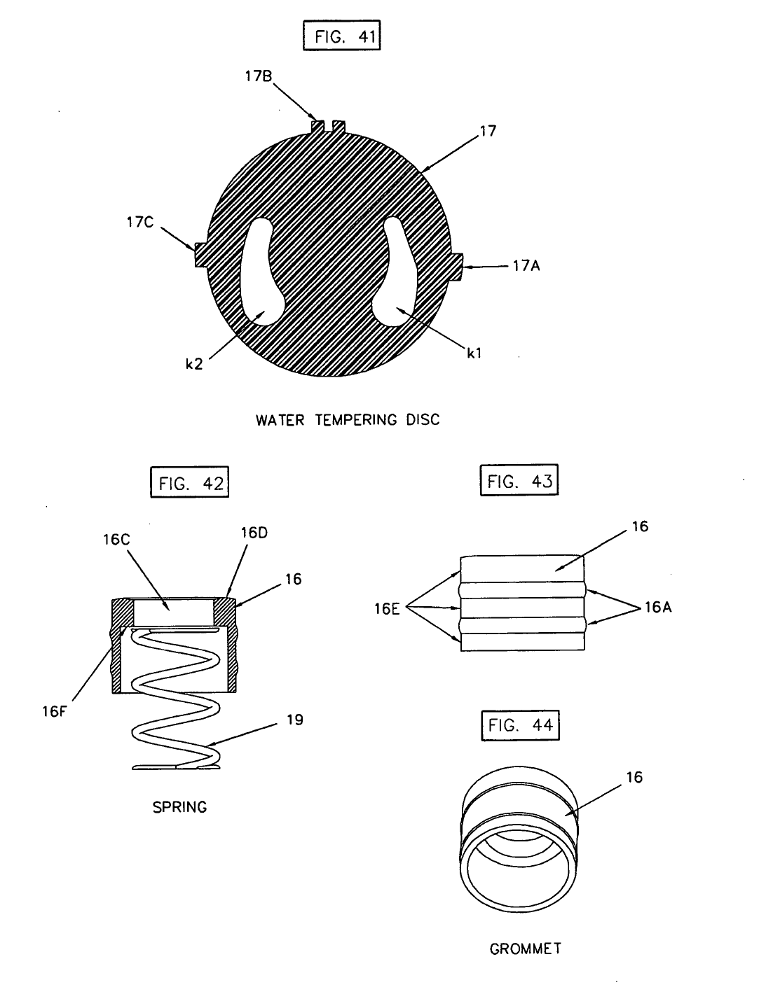

As best seen in FIG. 1, the spline extension extends down to the spline of the valve assembly which is in engagement with the diverting stem 27 which presses against a stainless steel disk 17 to keep said disk in engagement with sealing grommets 16 which are resiliently biased by spring members 19 to maintain pressure against this stainless steel disk 17. The diverting stem engages the stainless steel disk 17 via detents 27a through 27h engaging portions of 17a, 17b, and 17c of the stainless steel disk 17 as best seen in FIGS. 41 and 47. In this way, as the valve is operated, the stainless steel disk will rotate and provide for the flow of hot and cold water from the valve to exit into a mixing chamber defined between the said body 1 and said cartridge shell 10 as best seen in relation to FIG. 19. Said shell 10 therefore includes two halves which when assembled provide for the exterior of the cartridge that is seen in part in FIG. 21 and FIG. 20.

A shuttle assembly including a moveable sleeve 20 and a stationary sleeve 21 provides for the pressure compensating aspect of the valve assembly. The diaphragm 23 engages the moving sleeve 20 proximate the inner radius of said diaphragm and further engages the two meeting shell halves of the cartridge proximate the perimeter of said diaphragm 23. The anchored perimeter of the diaphragm allows for the flexing of the diaphragm and the movement of the moving sleeve 20 in relation to pressure differentials between the hot and cold water sources. For example assuming a steady state condition during operation of the valve and a subsequent operation of a toilet, this may cause a reduction in the flow of cold water to the valve and as a result, the hot water side of the valve construction will dominate and cause the motion of the pressure balancing device and the moveable sleeve 20 toward the cold water side. In doing so, the ports allowing water to flow into the hot water side of the valve will be shut down or closed somewhat in order to compensate for the pressure differential. This construction was described in my prior patent and the reader is referred thereto for a more detailed explanation of the diaphragm pressure balancing device. The details of that construction are hereby incorporated by reference in its entirety in relation to the diaphragm 23, moving sleeve 20 and the stationary sleeve 21 in relation to the pressure compensating aspects thereof. Please refer to FIG. 17 in this regard showing in the details of the moveable sleeve 20, stationary sleeve 21 and the diaphragm assembly 23 and the various openings for hot and cold water therethrough including opening 134h on the left side of the valve, opening 134c on the right side of the valve to allow water into chamber portions 135h and 135c respectively for hot and cold water causing the motion from left to right of the moveable sleeve 20 anchored to the diaphragm 23 to compensate for the pressure differentials. The hot and cold water as best seen in FIG. 17 will exit separately from the shuttle assembly from outlets 145h and 144c to exit ports 125h and 125c which contain the resiliently biased grommet 16 biased by said springs 19 in said ports to allow water to exit through outlets K1 and K2 provided in the stainless steel disk 17. These outlets are provided to permit exit of hot and cold water from the valve and to the mixing chamber defined between the body 1 and the cartridge assembly seen in FIGS. 17 and 18.

Referring to FIGS. 11 and 12 these illustrate the body nut 29 and the trim nut 28 best seen in FIGS. 1, 2 and 3. In order to maintain the cartridge previously described within the opening in the body 1 especially in relation to FIGS. 4 and 5, the trim nut and body nut assembly therefore as seen in FIGS. 1 and 2 capture the sleeve 26 which is sealed in relation to the cartridge via the trim nut and body nut which are threaded internally within openings 29a and 28a to receive the sleeve spline engaging the corresponding trim nut 28 and the body nut 29.

Below the trim nut and body body nut are disposed a stop 11 and a temperature controlling rim 12 that is best seen in relation to FIGS. 13 through 16 which are positioned so that portion 11a buts up against portion 12a so as to limit the rotation of the stainless steel disk 17 to prevent scalding of the bather. This attribute was described in my prior “089 US Patent” and the details thereof are incorporated by reference in their entirety in relation to this safety mechanism of a combination of the stop ring 11 and the temperature controlling 12.

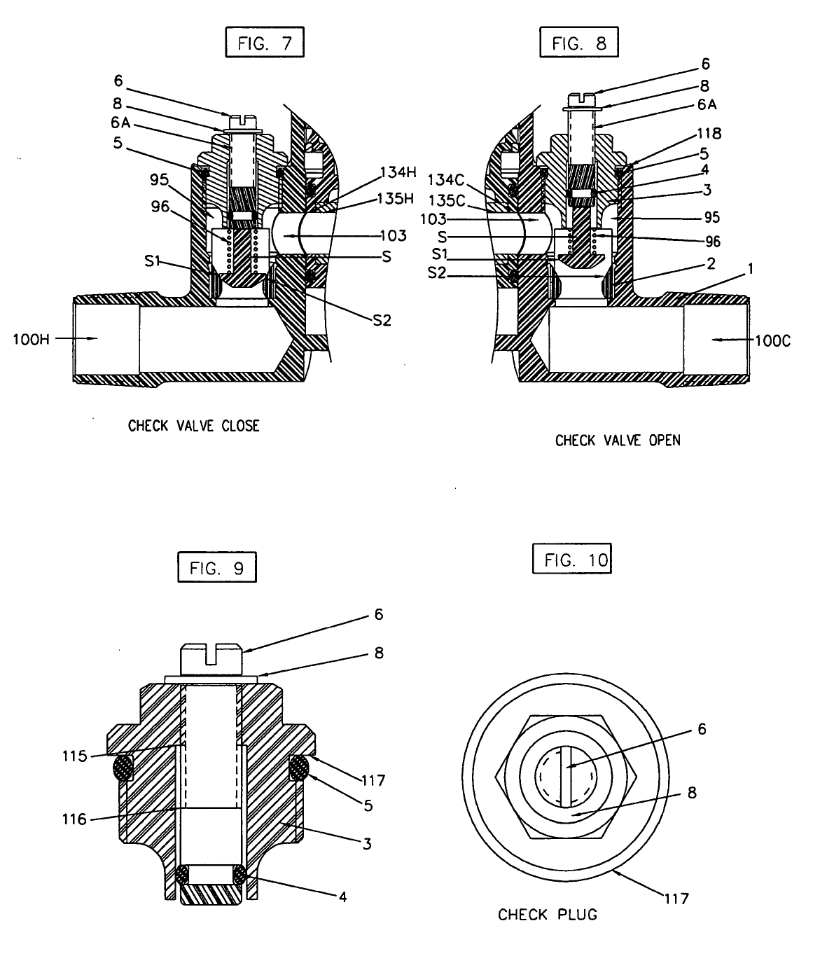

Referring now to the FIGS. 2, 3, 4, 5, and 6 as previously described housing 1 is included with the valve which includes hot and cold water inlets 100h and 100c to permit water to enter into the cartridge assembly through the NEOPEARLE™ check mechanisms 3 as best seen in FIGS. 7 and 8 which provides the flow of water from the hot water inlet 100H into the inlet 103 and thereafter into the shuttle assembly, but prevents the cross over of hot and cold water by the check member 3 resiliently biased by 96 against the sealing portions S1 and S2 of each of the check mechanisms 3.

The body therefore 1 includes a separate shower SH and tub outlet TB with the outlet to the tub being the preferred outlet in view of venturi 109 provided in the body. It is only with the operation of the typical diverting mechanism that the outlet will flow to the shower SH. In order to manufacture the valve from brass, for example, the valve body particularly 1 has a plug 24 inserted in a hole that was previously used for manufacturing in forming the inlet ports 103 which are subsequently plugged with a typically plug disk plug 24 anchored in position by bending the surrounding material at 98 and 99 to engage the beveled end of said plug 24.

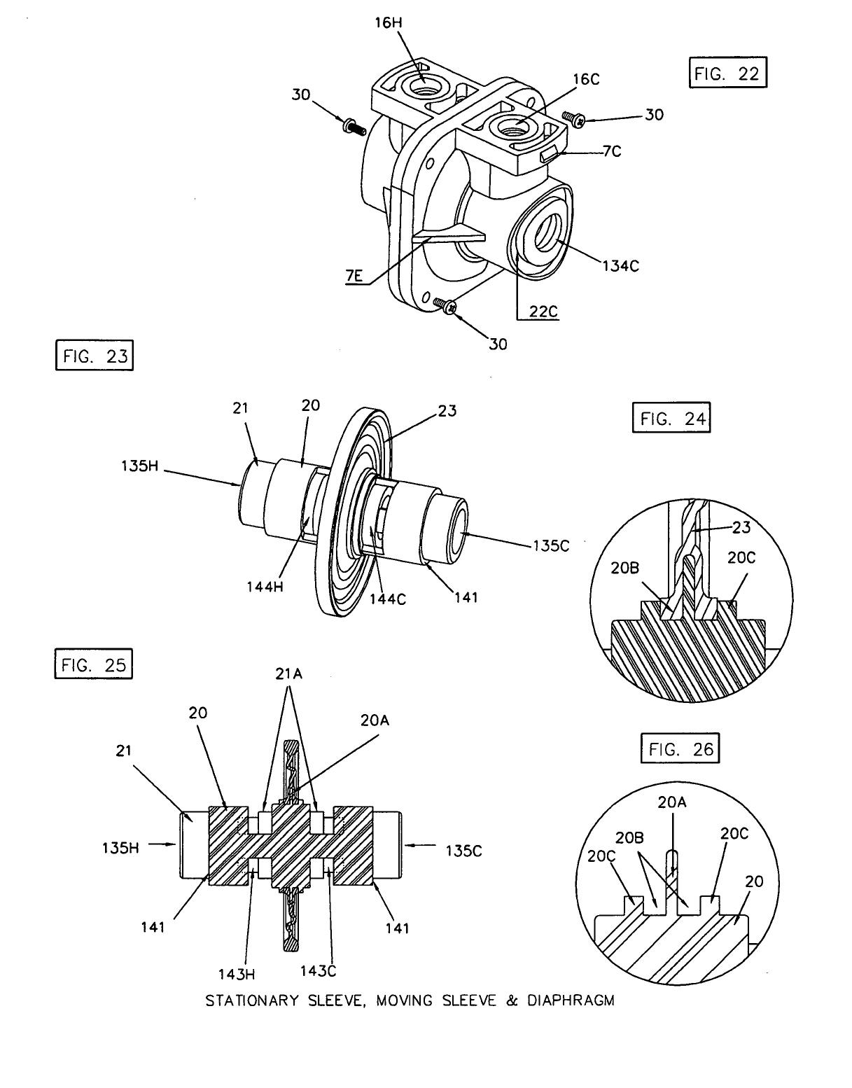

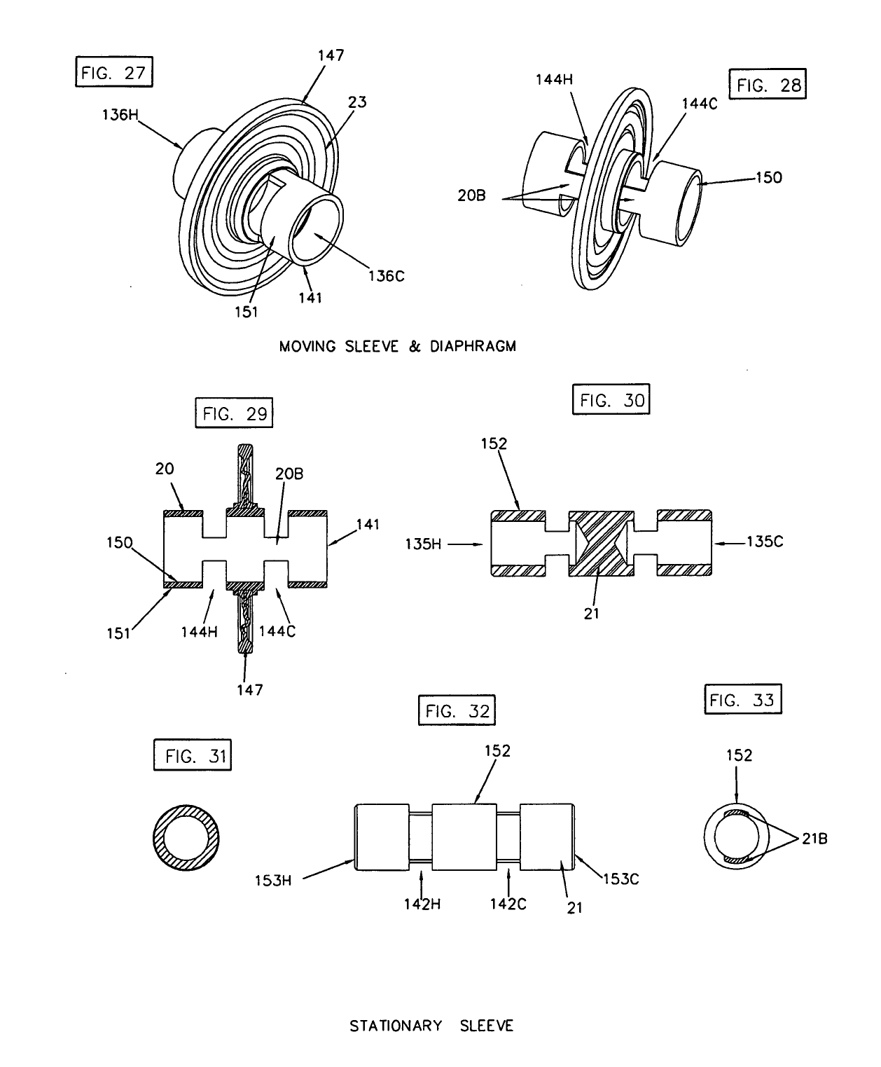

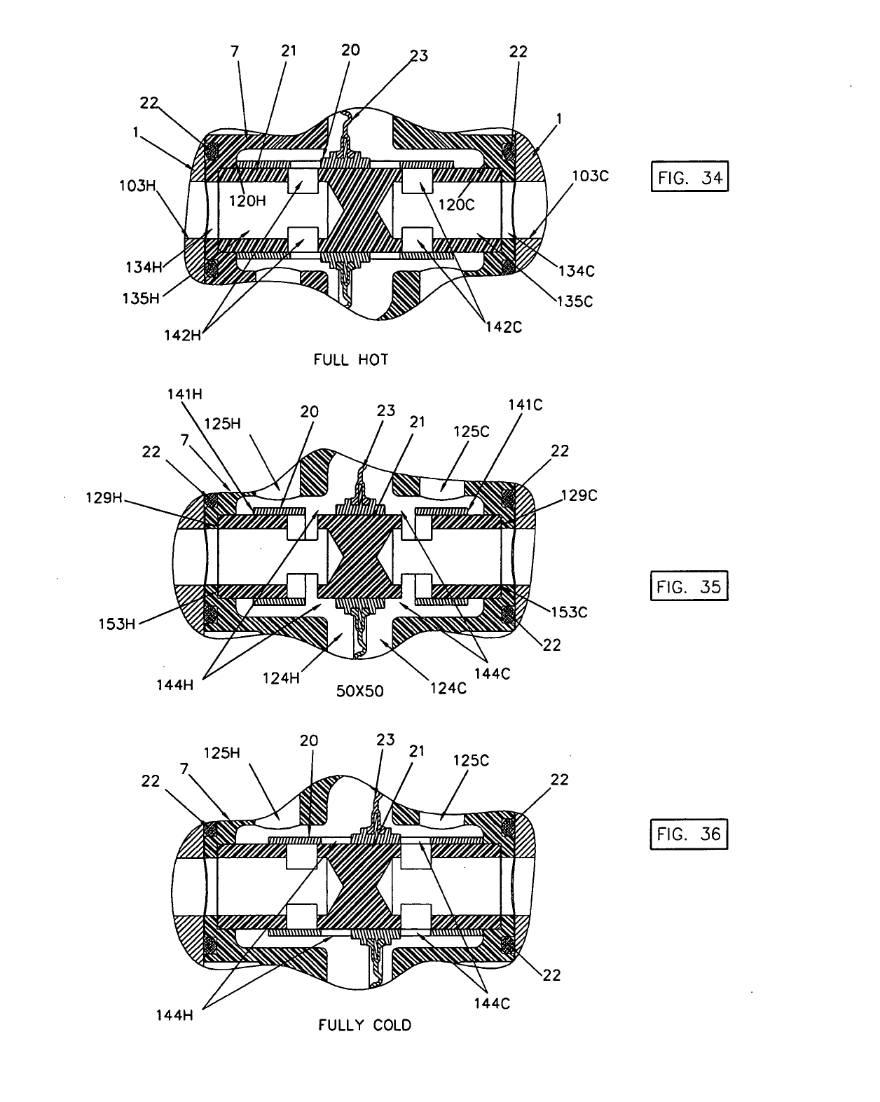

Referring now to FIGS. 22 through to 26 as shown the cartridge assembly includes outlets proximate the top thereof to engage with the outlets K1 and K2 of the stainless steel disk portion 17. The cartridge housing is illustrated as assembled by screws in which when assembling the cartridge anchors the diaphragm 23 proximate the perimeter thereof in the groove defined by the two mating shells as best seen in relation to FIG. 17 which groove anchors the perimeter of the diaphragm 23 but allows the motion of the moveable sleeve 20 on the stationary 21 as was described in prior paragraphs. Specifically referring to FIG. 24 the diaphragm is galvanized in place to the moveable sleeve 20 the details of which are seen with respect to portions 20a through 20c of the moveable sleeve in FIG. 26 and in FIG. 24 with the internal radius portion of diaphragm 23 being anchored in place as shown. Thus the diaphragm can move in compensation to pressure differentials within the valve assembly and corresponding shut off of the hot water supply in the manner previously described in my US patent 089', the details of which are incorporated by reference in their entirety in relation to the movement to the moveable sleeve 20 on the stationary sleeve 21 with the ports 143h and 143c being open and closed respectively in relation to these pressure differentials. It is extremely important that the tolerances between the moving sleeve 20 and the stationary sleeve 21 be extremely precise to provide for this motion previously described and yet prevent water from seeping out around the sleeves. This is best seen in relation to FIG. 27. A sequence of events for this pressure compensation for shutting off hot or cold water in the valve in events of water loss to either the hot or cold water flows is best seen in relation to FIGS. 34 and 36 which illustrates fully hot water passing through the valve assembly to a 50/50 mix of hot and cold water in FIG. 35 and fully cold water in FIG. 36. For example, referring to FIG. 35 it can be seen at 144h and 144c that the opening is partially closed for the water flow of hot and cold water to allow for the 50/50 flow. The illustrations in FIGS. 34 and 36 show the hot water at 142h fully open to the cold water 140c fully open in FIG. 36 with the cold water being fully closed at 142 in FIG. 34. These details will be fully understood by one skilled in the art especially in view of the knowledge of pressure balancing assemblies. The advantages of the diaphragm has been previously described both above and in my United States patent which responds more positively to pressure differentials than other pressure balancing constructions.

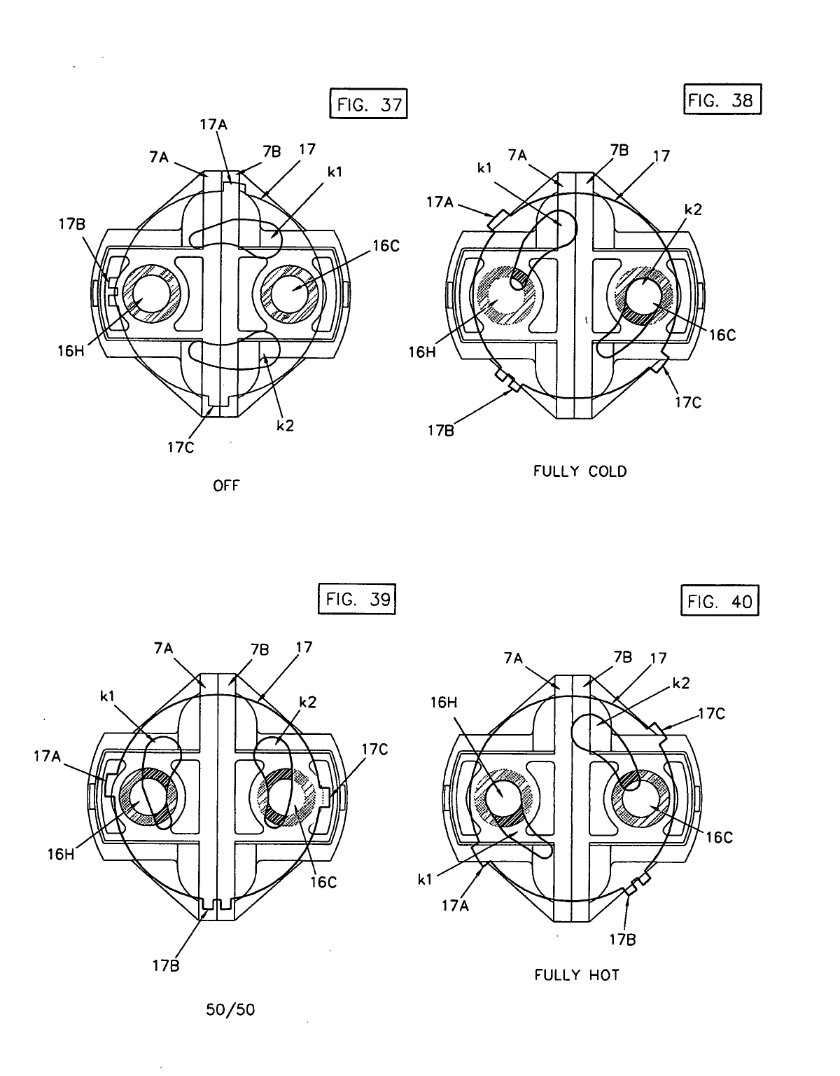

Refer now to FIG. 19 in relation to FIGS. 37 though 40 there is illustrated the motion of the stainless steel disk 17 in relation to the combined halves of the cartridge shells as best seen in FIG. 20. It will be noted that openings K1 and K2 of the stainless steel disk 17 are rotated in relation to the openings 16a and 16c of the cartridge assembly to allow for the flow through the valve from an off position as best seen in relation to FIG. 37 through to a fully hot position as best seen in relation to FIG. 40. The unique kidney shape of openings K1 and K2 of the stainless steel disk provide for an improved amount of input in the valve up to 10 gallons per minute. Please note that a very very small portion proximate tail end of openings K1 and K2 are necessary to allow a small flow of water into the valve at a fully cold and hot position as best seen in FIGS. 38 and 40. Otherwise, the shuttle operation would effectively shut off the hot or cold water supplies in these circumstances. Further as best seen in relation to the above mentioned Figures the detent portions 17a, b and c are fully viewed which will engage with previously described diverting stem 27 to allow operation in the valve. This is also seen in relation to FIG. 41.

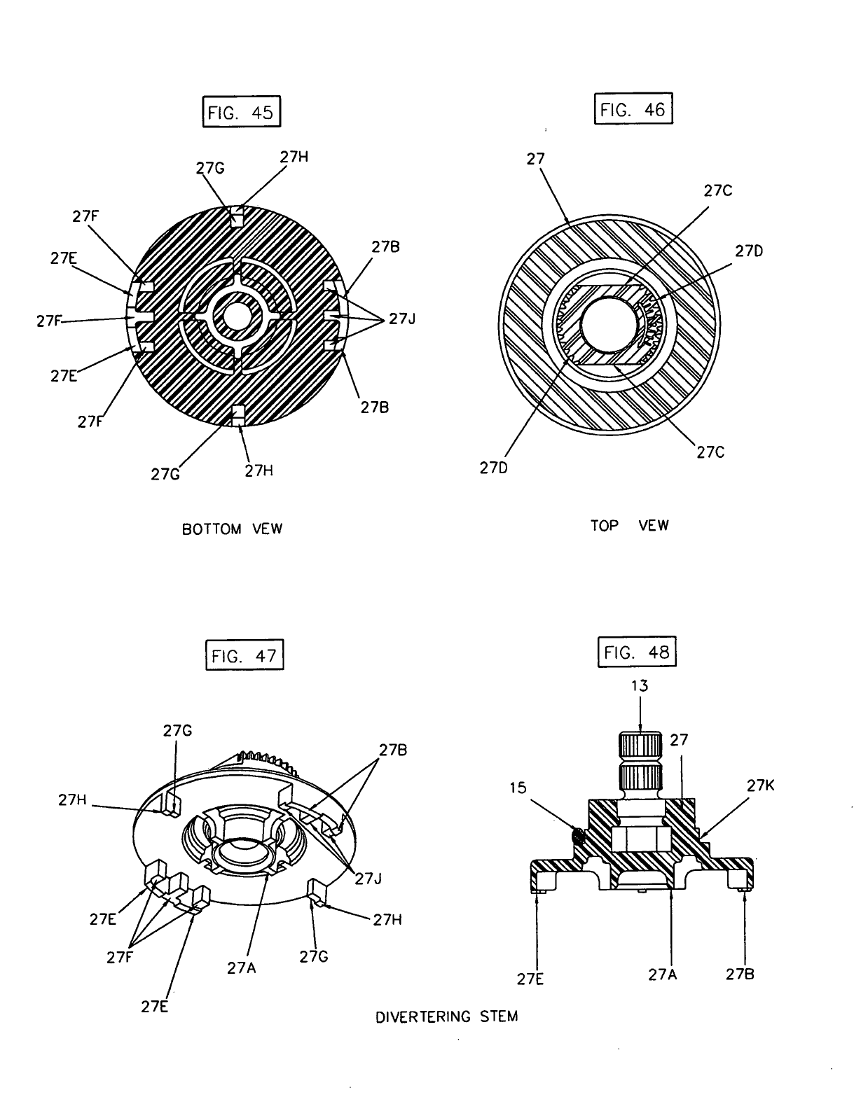

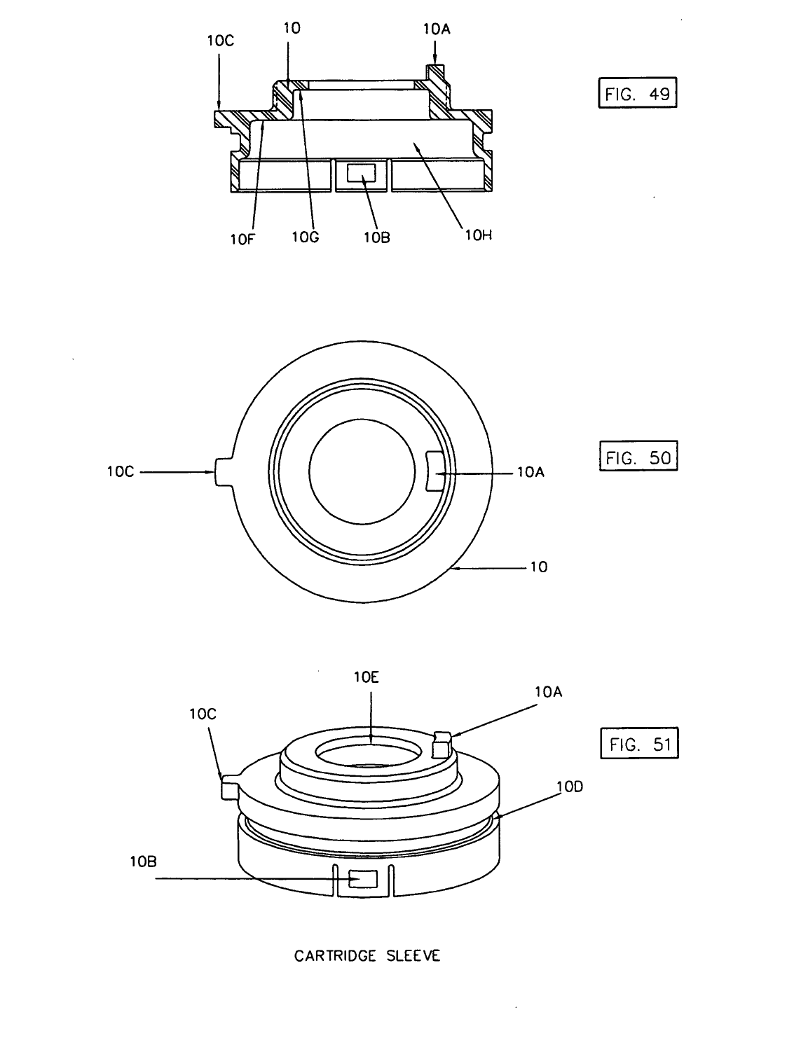

FIGS. 42, 43 and 44 illustrate the details of resilient seal 16 in position in opening 16, biased by 19 against the stainless steel disk 17 to ensure a positive operation of the valve when the stainless steel disk engages the diverting stem seen in relation to FIGS. 45 through 48 proximate detent portions 27a through 27h. Rotation therefore of the diverting stem 27 will cause rotation of the stainless steel disk 17 engaged in the corresponding detent portions. No other elements of the valve assembly move. All other valve elements are stationary. A cartridge sleeve 10 best seen in relation to FIGS. 49 through 51 engage and holds in position the diverting stem 27 for movement thereof, the cartridge sleeve being stationary and accommodates the operation of the valve cartridge assembly. The cartridge sleeve is held in position on the body specifically by detents 10a with other detents provided on the body which is known in the art as best seen in relation to FIGS. 17 and 18.

Referring generally to all of the Figures, it can be seen that a very compact single handle valve construction is provided which minimizes the wear and tear in the valve by the motion of the stainless steel disk 17 to allow water to exit from the cartridge assembly. In my previous construction “089' patent” the entire shuttle assembly also moved at the same time as the operation of the handle portion. In doing so, a less accurate pressure compensation was provided in a very complex manner. The present invention is simple and easy to manufacture and reliable. The cartridge assembly may be replaced on the run by closing check plugs 3 and preventing flow into the valve to allow for simple replacement of the entire cartridge assembly by the removal of the trim nut and body nut only. Replacement of the cartridge and simple assembly of the trim nut and body nut makes the cartridge assembly repairable by the user. Once the cartridge is replaced, the check plugs are opened to allow water to flow back into the valve assembly.

As many changes can be made to the preferred embodiments of the invention without departing from the scope thereof. All material disclosed herein is to be considered illustrative of the invention but not in a limiting sense.

The embodiments of the invention in which an exclusive property or privilege is claimed are as follows:

1. An improved diaphragm pressure balancing valve assembly comprising a valve body having inlet and outlet ports for the flow of water into the valve and from the valve to a shower or a spout, said body including an opening being generally cylindrical at one end thereof to receive a cartridge assembly, said cartridge assembly including inlet and outlet parts for alignment with the inlet and outlet ports of the body, said cartridge including a stationary pressure balancing device, namely a cylinder upon which rides a shuttle assembly including a diaphragm responsive to pressure differences causing the motion of the shuttle on the cylinder assembly, said diaphragm including a pressure balancing area at each side proximate the hot and cold water entry into the cartridge, the assembly including selective hot and cold water outlet ports in engagement with a disc assembly being moveable in relation to each of the hot and cold water outlet ports of the cartridge, each outlet being sealed by resiliently biased seals against which the disc presses, said disc being rotatable to and from positions allowing water to pass out of the cartridge, and then around the mixing chamber located between the body and the cartridge and subsequently exiting the valve to a spout or a shower, the disc being held in position and being press fit in engagement with a cartridge sleeve and with a stem portion of the valve, said cartridge being held in position by supplementary members of the housing for example including a trim nut and body nut to ensure a press fit between the members and the disc; wherein a much simplified, compact, cost effective device has been provided with the pressure balancing shuttle being substantially stationary as the valve is operated.

2. The assembly of claim 1 wherein said disc is a stainless steel disc.

3. The assembly of claim 2 wherein the stainless steel disc includes cooperating hot and cold water outlets having a generally kidney-shaped construction including a bulbous head at one end and a tail like portion at the other to increase flow through the valve in relation to prior art embodiments.

4. The assembly of claim 3 wherein any equivalently performing shape to the kidney shaped construction for the openings is substituted for the kidney shaped openings.

5. A stainless steel disc assembly for the improved diaphragm pressure balancing assembly of claim 1 to 4 wherein said pressure balancing assembly within said valve assembly is stationary and the shuttle does not move with the operation of the cartridge but only in response to pressure differentials and only the stainless steel disc moves as the cartridge is operated from the desired positions such as from the comfort positions for the individual using the valve.

6. A single handle pressure balancing mixing valve comprising a cartridge incorporating a non-rotatable pressure balancing mechanism within said cartridge, said valve including an actuating stem to which a handle is attached and rotated to operate the valve, in rotating the stem a water flow control platen, having enlarged offset hot and cold openings are moved to open or shut off the hot or cold water flow exiting the cartridge to a mixing chamber defined between the body and the cartridge, the cartridge including a pressure chamber on either side of a diaphragm equipped shuttle which responds to changes in pressure in the respective chambers to throttle the water through the valve in response to changes in inlet pressures, the cartridge allowing the flow of separate hot and cold water to the water flow control platen, in operation said platen being pressed against two separate hot and cold water spring biased seals surrounding the exit ports from the cartridge downstream of the balancing chamber, wherein the cartridge is accessible and removable from the stem end of the valve mechanism by the simple removal of a retainer.

7. The valve of claim 6 wherein the openings of said platen are substantially kidney shaped.

8. The valve of claim 6 or 7 wherein said platen is made from stainless steel,

9. The valve of claim 6 wherein said diaphragm sleeve type balancing mechanism is slidably mounted on a stationary tube in the cartridge, which assures a smooth immediate response to small fluctuations in supply pressure during operation of the valve and at the same time, by maintaining the diaphragm stationary as taught with this improvement, the resulting balancing mechanism is more precise in its action as well as less prone to “sticking” due to the accumulation of scale and sludge on the balancing sleeve.

10. The valve of claim 1 or 6 further comprising the inclusion of an adjustable stop mechanism to adjust and limit the rotational travel of the platen so that the flow of the hot water may be restricted to a preset flow rate by adjusting the position of the hot water stop of the valve, which is conveniently carried out from a point outside the valve housing even after the valve is permanently installed and water is flowing in the valve.

11. The assembly of claim 1 or 6 wherein at any point in time both the hot and cold water flows can be shutoff by operating stops conveniently built into the body of the valve disposed at the inlets.

12. A single handle pressure balancing mixing valve of claim 1 or 6 which in utilizing comparatively large water passageways is essentially silent in operation and not prone to producing water hammer.
